(19) United States
(12) Patent Application Publication
(10) Pub. No.: US 2020/0395856 A1
(43) Pub. Date: Dec. 17, 2020

(54) APPARATUS AND METHOD OF CALCULATING IMPROVED CONTROL PARAMETERS FOR COMPACT LCC BASED RESONANT POWER CONVERTERS FOR ELECTRIC VEHICLE BATTERY CHARGERS

(71) Applicants: Nayeem Arafat, San Dimas, CA (US); Robert T. Ryan, San Dimas, CA (US)

(72) Inventors: Nayeem Arafat, San Dimas, CA (US); Robert T. Ryan, San Dimas, CA (US)

(21) Appl. No.: 16/017,905

(22) Filed: Jun. 25, 2018

(51) Int. Cl. H02M 3/335; H02J 7/00; H02M 1/34; B60L 11/18

(52) U.S. Cl. CPC H02M 3/33569; H02J 7/0052; H02M 1/34; B60L 2210/10; H02J 2007/0059; H02M 2001/346; B60L 11/1811

(57) ABSTRACT

A method of calculating optimum control parameters for a LCC resonance power converter for an electric vehicle charger and an LCC power converter configured by such method, specifically, a method of selecting MOSFET switching rates in proportion to the associated snubber capacitors for the purpose of minimizing power stresses and improving switch performance and longevity, and reducing warranty and repair costs.

### FIELD OF THE PRESENT DISCLOSURE

This disclosure relates generally to onboard battery charger modules for electric vehicles and more specifically to an improved apparatus and method of calculating control parameters for an LCC based resonant power converter resulting in reduced electrical switch stresses yielding improved switch performance and operational longevity.

### BACKGROUND OF THE RELATED ART

An important component of an electrically powered vehicle is the onboard charging module. The function of the onboard charging module is to assist an electrical vehicle to accept and condition electrical power from various external power sources for the purpose of charging the vehicle's onboard batteries, or other direct electrical power storage system.

Typically, an onboard charging module will condition the external power source in two stages. The first stage is a power factor correction (PFC) stage that will convert alternating current (AC), whether single or three phase, into direct current (DC), and the second phase, often called a resonant power converter (LCC), also called a series-parallel power converter (SPRC), is a DC to DC power converter that will scale the newly converted DC power to an appropriate DC voltage for charging the onboard battery while also regulating the DC amperage to appropriate levels and providing electrical isolation. The LCC configuration is necessary for isolation purposes and to make the ground-fault circuit interrupter (GFCI) lower than 6 mA to meet standard OEM guidelines.

In construction, the LCC based power converter typically comprises a plurality of wide band MOSFET switches (Si, SiC, GaN, etc.) arranged in series-parallel orientation and a resonant tank including the standard components: a resonant inductor; a resonant capacitor; a parallel capacitor across the secondary winding of the transformer to regulate the power to a wide battery voltage range (approximately 200 V to 450 V).

Typically, the series-parallel MOSFET switches involve four switches designed to operate on a 50% duty cycle and each MOSFET switch is accompanied by a diode and snubber capacitor placed in parallel such that during the period of time when the switches are open, also called the “dead time,” either the diode or snubber capacitors will conduct. This arrangement is designed to reduce the turn-off loses and electrical stresses on the MOSFET switches for the purpose of improving electrical efficiency and switch longevity.

The snubber capacitor achieves this purpose by slowing down the rise of the switch voltage at the point of switch turn-off. However, if the snubber capacitor is too large or the dead time is too short, there may not be adequate time to charge and discharge the capacitor during each switching cycle causing the energy stored within the capacitor to be expended in the switch. This is inefficient and causes unwanted electric stresses which are not conducive to efficiency or the long-term integrity or operational longevity of the switch. From a production perspective, this can also drive up costs associated warranties and repairs.

Conversely, if the snubber capacitance is too small or the dead time is too long, the resonant current may not stay negative which is also undesirable from a charging perspective and can cause electrical stresses that negatively impact component longevity. Precisely balancing the MOSFET switching dead time to the capacitor size is critically important to achieving maximum performance including electrical efficiency and minimizing the electrical stresses on the MOSFET switches.

In legacy products, the MOSFET switching dead times are often roughly estimated through theoretical calculations alone or by theoretical estimations slightly improved by trial and error; therefore, optimal MOSFET switching efficiency and/or operational longevity is not often realized. There exists a need for a method to precisely calculate the optimal MOSFET switching dead times for the associated snubber capacitor sizes for the purpose of constructing a LCC based resonant power converter that performs at optimal efficiency and demonstrates optimal operational longevity.

The present disclosure distinguishes over the related art providing heretofore unknown advantages as described in the following summary.

### BRIEF SUMMARY OF THE INVENTION

The present disclosure describes an innovative method of calculating improved control parameters for a LCC based resonant converter resulting in reduced electrical switch stresses yielding improved switch performance and operational longevity which translates to warranty and repair cost savings.

As previously discussed, it is critical to the effort of achieving the optimal electrical efficiency of an LCC resonant converter to precisely calculate the most appropriate MOSFET switching dead time for the selected snubber capacitor.

To achieve this precise switching rate, one must begin by constructing the theoretical model of the series-parallel LCC resonant power converter in mind and populate the resonant tank variables with representative values (i.e. the resonant inductor, resonant capacitor, parallel capacitor, magnetizing inductance, and transformer ratio). Once created, curves of the theoretical output current and resonant current as a function of switching frequency can be generated for various voltages throughout the anticipated operational voltage range.

From these theoretical curves, certain threshold critical values may be determined, such as the minimum acceptable switching frequency (f_{range}) through the anticipated range of voltage, determined by the switching frequency point at which output current goes to zero. This critical value may then be used to determine the associated resonant current (i_{q1off}) at the newly identified minimum switching frequency (f_{range}).

With those critical values determined, one can then calculate the maximum acceptable capacitance of the snubber capacitors in the theoretical model using the following relationship: C_{ds_n}=(0.5*f_{range})*(i_{q1off})/2V_{input DC Bus}, where f_{range} is the previously determined minimum acceptable switching frequency for the anticipated voltage range, i_{q1off} is the associated resonant current at such minimum acceptable switching frequency (f_{range}), and V_{input DC Bus} is the upper end of the anticipated input voltage range.

Once the maximum acceptable capacitance (C_{ds_n}) for the model resonant converter is calculated, a more commercially available and/or economical capacitor size may be chosen so long as it does not exhibit capacitance greater than the calculated maximum acceptable capacitance (C_{ds_n}).

The next step in the process, after selecting such commercially available and/or more economical capacitor, is to precisely calculate the time required to discharge the chosen capacitor. Such calculation can be made using the following relationship: t_{discharge}=C_{eqv}*V_{bus}/i_{res turn-off}, where C_{eqv}=C_{chosen}+C_{chosen}+2*Cₒₛₛ, where C_{chosen}=the capacitance of the chosen capacitor and Cₒₛₛ=MOSFET switch non-linear output capacitance.

Finally, the MOSFET switches must be programmed to exhibit a dead time that is greater than the calculated discharge time (t_{discharge}) and less than or equal to 105% of the calculated discharge time. Calculating the dead-time by this method will reduce electrical stresses yielding increased operational longevity of the MOSFET switches compared to legacy methods, and thereby also lead to lower warranty and repair costs.

This disclosure teaches certain benefits in construction and use which give rise to the objectives described below.

A primary objective inherent in the above described apparatus and method is to provide advantages not taught by the prior art.

Another objective is to provide an improved method of calculating the most appropriate switching rate so as to reduce the power stresses and related failures of MOSFET switches in an LCC power converter.

A further objective is to provide an improved method of calculating the most appropriate switching rate to increase the operational life span of MOSFET switches in an LCC power converter.

A still further objective is to provide an improved method of calculating the most appropriate switching rate so as to reduce the warranty and repair costs associated with MOSFET switch failure in LCC power converters.

Other features and advantages of the present invention will become apparent from the following more detailed descriptions, taken in conjunction with the accompanying drawings, which illustrate, by way of example, the principles and features of the presently described apparatus.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is an exemplary theoretical schematic of an LCC based resonant power converter including four MOSFET switches in a parallel series configuration and a simple resonant tank.

FIG. 2 is a set of graphs illustrating the voltage and current through the MOSFET switch as well as the resonant current during a complete switching cycle of an LCC power converter, the switching cycle is divided into stages labeled A, B, C, D, and E for reference.

FIG. 3 is a pair a graphs illustrating theoretical output current and resonant current as a function of switching frequency used to determine critical values within the anticipated voltage range which are generated using the exemplary theoretical schematic of an LCC resonant power converter set forth in FIG. 1.

FIG. 4 is a series of graphs illustrating the relationship between the voltage and current through a MOSFET switch as a function of time, each graph depicts the curve of a different size snubber capacitor for comparison.

FIG. 5 is a graph illustrating the power dissipated in the MOSFET switch as a function of time for each of the three different snubber capacitors featured in FIG. 4.

FIG. 6 is a graph illustrating the voltage through a single MOSFET switch in an LCC power converter, the current through the associated parallel diode, and the resulting pulse width modulation when the MOSFET switch is programmed with too little dead-time to fully discharge the chosen snubber capacitor.

FIG. 7 is a graph illustrating the voltage through a single MOSFET switch in an LCC power converter, the current through the associated parallel diode, and the resulting pulse width modulation when the MOSFET switch is programmed with proper dead-time to fully discharge the chosen snubber capacitor.

FIG. 8 is a graph illustrating the voltage through a single MOSFET switch in an LCC power converter, the current through the associated parallel diode, and the resulting pulse width modulation when the MOSFET switch is programmed with too much dead-time to fully discharge the chosen snubber capacitor.

### DETAILED DESCRIPTION OF THE EXEMPLARY EMBODIMENT

The above described drawing figures illustrate an exemplary embodiment of the presently disclosed apparatus and its many features in at least one of its preferred, best mode embodiments, which is further defined in detail in the following description. Those having ordinary skill in the art may be able to make alterations and modifications to what is described herein without departing from the spirit and scope of the disclosure. Therefore, it must be understood that what is illustrated is set forth only for the purposes of example and that it should not be taken as a limitation in the scope of the present apparatus or its many features.

Described now in detail is an improved apparatus and method of calculating control parameters for an LCC resonant power converter resulting in reduced MOSFET (Si, SiC, GaN, etc.) switch stresses yielding improved switch performance and operational longevity.

As previously described, to calculate precise control parameters for an LCC power one must begin by constructing a theoretical model of such power converter and populate the resonant tank variables with representative values.

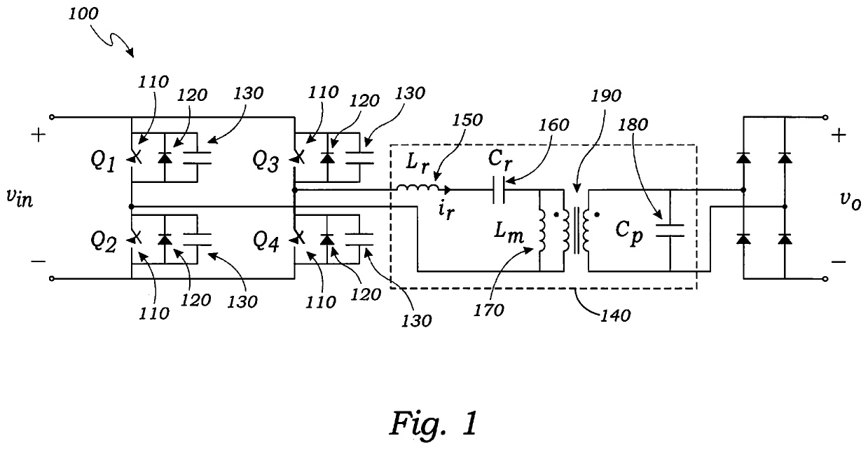

FIG. 1 illustrates such theoretical model including four MOSFET switches 110 in a parallel-series configuration for a 50% duty cycle, each with an accompanying parallel diode 120 and snubber capacitor 130. Also depicted is the resonant tank 140, including a resonant inductor (Lᵣ) 150, a resonant capacitor (Cᵣ) 160, parallel capacitor (Cᵣ) 180, magnetizing inductor (Lₘ) 170 and transformer with ratio (n) 190.

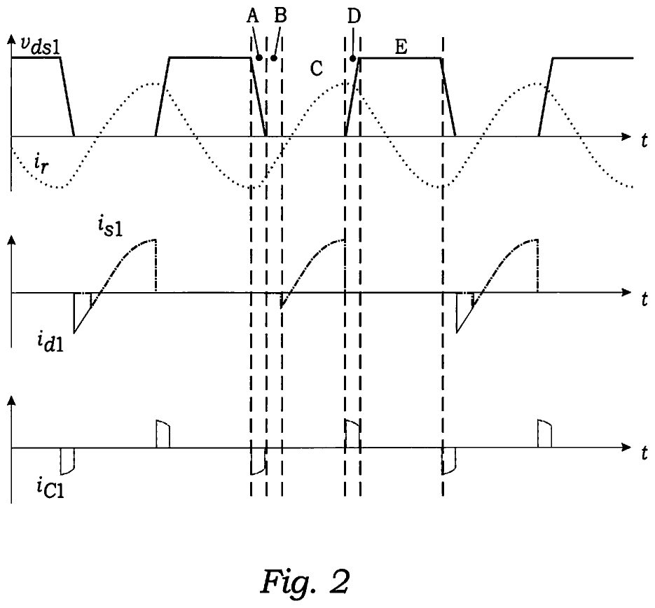

FIG. 2 illustrates a complete switching cycle of the exemplar LCC power converter depicted in FIG. 1. The switching cycle is divided by specific portions labeled A,B,C,D, and E by vertical dashed lines for ease of reference.

During portion A Q₁ and Q₄ are turned off and Q₂ and Q₃ are transitioning to the off position. During this portion of time the resonant currant (iᵣ) is negative and to ensure that the resonant current flow through Lᵣ 150 stays continuous, the resonant current will discharge snubber capacitors 130 C_{ds1} and C_{ds4} and charge snubber capacitors 130 C_{ds3} and C_{ds2} until voltage V_{ds1} and V_{ds4} become zero.

After V_{ds1} and V_{ds1} become zero portion B of the switching cycle begins. In portion B, the resonant current (iᵣ) forces the body diodes 120 of Q₁ and Q₄ to become forward biased and conduct; therefore, in portion B, the current through the diodes 120 (i_{d1} and i_{d4}) equals the resonant current.

Portion C begins after a dead-time of an appropriate length when MOSFET switches 110 Q₁ and Q₄ turn on. The voltage should be zero at the moment of switching; therefore, the resonant current will flow through switches 110 Q₁ and Q₄ and the current (iₛ₁ and iₛ₄) will equal the resonant current.

At the beginning of portion D MOSFET switches 110 Q₁ and Q₄ start to transition to the off position while switches 110 Q₃ and Q₂ remain in the off position. This causes the resonant current to simultaneously discharge snubber capacitors 130 C_{ds2} and C_{ds3} while charging snubber capacitors 130 C_{ds1} and C_{ds4} until V_{ds1} and V_{ds4} reach peak value.

And finally, portion E is similar to portion B and C except that instead of the MOSFET switches 110 Q₁ and Q₄ and associated diodes 120 conducting, the switches 110 and diodes 120 of Q₂ and Q₃ conduct. This concludes a single switching cycle and the process repeats.

Using representative values for each of the resonant tank variables and the value of the anticipated range output voltage, the theoretical model of the power converter illustrated in FIG. 1 can be used to generate graphs of output current and resonant current as a function of switching frequency.

FIG. 2 illustrates such graphs calculated for anticipated output voltages of 200 V, 360 V, and 400 V using a 25 μH resonant inductor 150, a 282 nF resonant capacitor 160, a 33 nF parallel capacitor 180, a value of 250 μH for the magnetizing inductance 170, and a transformer 190 with a 1:1 ratio.

An analysis of the output current v. switching curve illustrated in FIG. 2 indicates that, for output voltage of 200 V, the output current goes to zero at approximated 333 kHz, therefore f_{range}=333 kHz. Then, by referencing the resonant current v. switching frequency curve, one can observe that at 333 kHz the resonant current (i_{q1off}) is approximately 10 amperes.

Using these critical values determined from the graphs in FIG. 2, one can calculate the maximum acceptable capacitance for the snubber capacitors using the equation: C_{ds_n}=(0.5*f_{range})*(i_{q1off})/2V_{input DC Bus}, where f_{range} is the previously determined minimum acceptable switching frequency (333 kHz) and i_{q1off} is the associated previously determined resonant current at that frequency (10 amps).

In this particular exemplar calculation, the maximum acceptable capacitance for the snubber capacitor is calculated to be 18.75 nF. This value represents the upper limit of acceptable capacitance for this LCC power converter. In practice, a commercially available capacitor may be chosen so long as it exhibits capacitance equal to or lower than the calculated theoretical maximum.

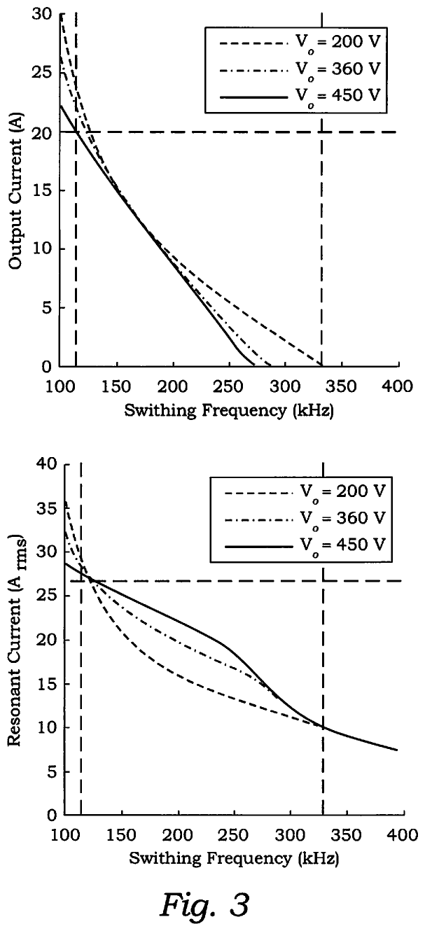

For this exercise, three commercially available capacitor sizes are considered with the following capacitance ratings: 0.1 nF, 1 nF, and 10 nF. Each of these capacitors are Jo acceptable as they exhibit capacitance lower than the theoretical maximum; however, the graphs in FIG. 3 help determine the best choice among the acceptable options. FIG. 3 illustrates the voltage and current through the MOSFET switch 110 at turn-off and indicates that as the snubber capacitor 130 size is increased, the voltage rise time decreases. Lower voltage rise time reduces the power dissipated in the switch, therefore, the best choice is the capacitor with the largest capacitance that is smaller than the previously calculated theoretical maximum (C_{ds_n}=0.18.75 nF).

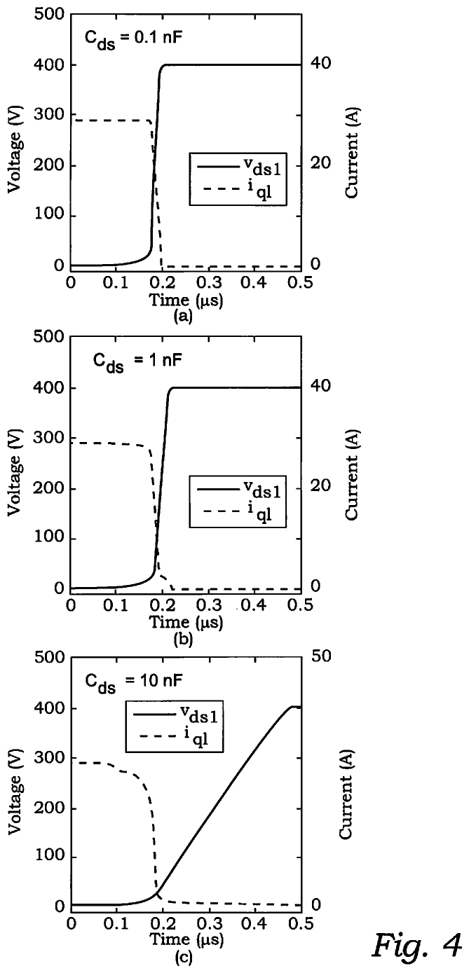

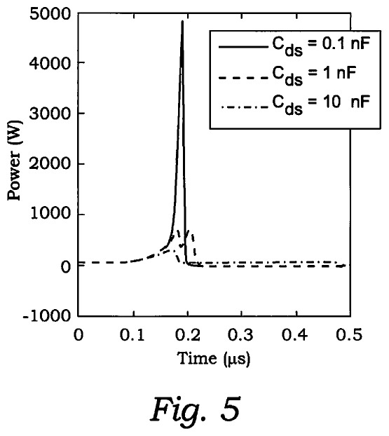

FIG. 4 illustrates this point more explicitly by graphing power dissipated during the same switch turn off moment. The large spike associated with the 0.1 nF represents a relatively large quantity of power being dissipated through the switch at turn off compared to the curve representing the 1 nF capacitor. Again, the conclusion is that the most ideal commercially available snubber capacitor is the capacitor that exhibits the largest capacitance that is still equal to, or smaller than, the previously calculated theoretical maximum capacitance.

Once a particular capacitor is chosen, a precise MOSFET switching speed can be determined by calculating the discharge time using the chosen snubber capacitor and the following relation: t_{discharge}=C_{eqv}*V_{bus}/i_{res turn-off} where C_{eqv}=C_{chosen}+C_{chosen}+2*Cₒₛₛ where V_{bus}=the input bus voltage, C_{chosen}=the capacitance of the chosen snubber capacitor and Cₒₛₛ=MOSFET non-linear output capacitance.

After having calculated the precise discharge time for the chosen snubber capacitor 130, the MOSFET switches 110 should be programed with a dead-time within the range defined by the calculated discharge time (t_{discharge}) and 1.05 t_{discharge}. That is, the t_{deadtime} must be greater than t_{discharge} and less than or equal to 105% of t_{deadtime}.

An LCC resonant power converter with MOSFET switches programmed with dead-times calculated by this innovative will result in reduced electrical switch stresses yielding to improved MOSFET switch performance and operational longevity which, in turn, also leads to decreased repair and warranty costs.

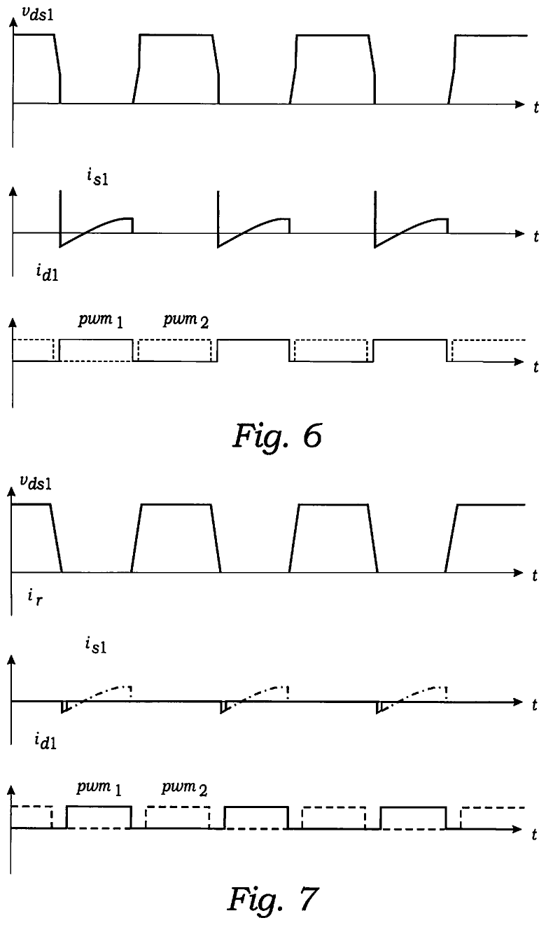

FIGS. 6, 7, and 8 further illustrate the effects the dead-time calculation has on the resultant waveform. Specifically, FIG. 6 depicts an exemplar waveform when the switching time is too short to allow the snubber capacitor 130 to fully discharge. In such cases, the MOSFET switch 110 loses its zero-voltage switching causing a large spike of current at turn-on caused by the energy stored in the capacitor 130 that was not allowed adequate time to discharge during the dead-time, and therefore, the switch diode 120 never conducts, always remaining zero.

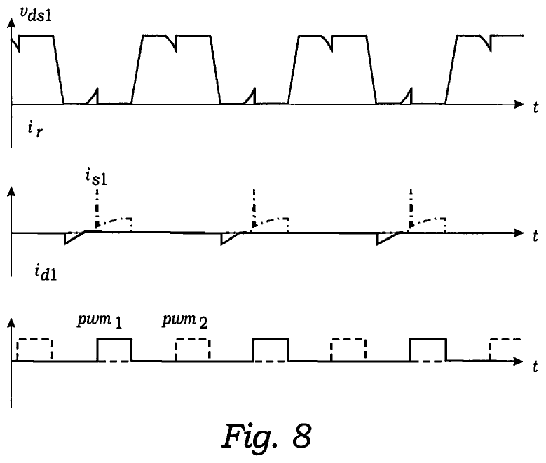

Conversely, FIG. 8 illustrates an LCC converter waveform when the MOSFET switches are programmed with a dead-time that is too long for the chosen snubber capacitors 130. In such cases, the resonant current has already become positive by the time the MOSFET switch 110 turns on. Consequently, the resonant current begins to recharge the snubber capacitor 130 and the MOSFET switch 110 loses its zero voltage turn-on resulting in large current spikes as the energy stored in the snubber capacitor 130 is dissipated through the switch 110.

When the dead-time is optimized precisely for the selected snubber capacitor 130 by the presently disclosed method the resultant waveform looks like FIG. 7, with low-stress, zero-voltage turn-ons and no rapidly dissipating energy creating spikes. Implementing such method will reduce LCC power converter failures by facilitating longer MOSFET switch 110 lifespans and will inevitably lead financial savings associated with fewer repairs and lower warranty costs.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method of calculating control parameters for a compact resonant converter in an onboard charger module that will exhibit reduced electrical switch stress and improved operational longevity, said method comprising the steps of:
constructing a theoretical computer model of a series-parallel resonant converter circuit to determine a theoretical minimum switching frequency (f_{range limit}) that can produce a desired range of output amperage;
calculating the maximum possible snubber capacitors capacitance (max C_{ds_n}) usable for the circuit while still maintaining the desired range of output amperage using the equation max C_{ds_n}=(0.5*f_{range})*(i_{q1off})/2V_{input DC Bus};
choosing a commercially available snubber capacitors that exhibits capacitance (C_{chosen}) lower than the previously calculated max C_{ds_n};
calculating the time required for the chosen snubber capacitors to fully discharge (t_{discharge}) using the following equation t_{discharge}=C_{eqv}*V_{bus}/i_{res turn-off} where C_{eqv}=C_{chosen} C_{chosen}+2*Cₒₛₛ where Cₒₛₛ=MOSFET non-linear output capacitance;
Programming the MOSFET switching speed to allow dead time t_{deadtime} to equal 1.05*t_{discharge}, thereby avoiding either too little or too much dead-time to discharge the snubber capacitors and realizing reduced electrical switch stress and increased switch operational longevity.

2. A compact resonant converter in an onboard charger apparatus capable of exhibiting reduced electrical switch stress and increased operation switch longevity, said apparatus comprising:
a resonant tank featuring a resonant inductor, a resonant capacitor, an isolation transformer, and a parallel capacitor;
a plurality MOSFET switches; and
a snubber capacitor in parallel with each said MOSFET switch, wherein the MOSFET switching time t_{deadtime} is programmed proportionate to the capacitance of the snubber capacitors such that t_{deadtime} is greater than t_{discharge} but less than or equal to 1.05*t_{discharge}; where t_{discharge}=(C_{eqv}*V_{bus}/i_{res turn-off}) where C_{eqv}=C_{chosen}+C_{chosen}+2*Cₒₛₛ), thereby reducing MOSFET switch stress and increasing operational MOSFET switch longevity.
